(19) United States
(12) Patent Application Publication
(10) Pub. No.: US 2010/0179954 A1
(43) Pub. Date: Jul. 15, 2010

(54) Quick Mass Data Manipulation Method Based on Two-Dimension Hash

(75) Inventors: MIN CHEN, Nanjing (CN); LIBIN SUN, Nanjing (CN); BIN LIANG, Nanjing (CN); GUOXIANG LIU, Nanjing (CN); JIARONG ZHANG, Nanjing (CN)

Correspondence Address: GLOBAL IP SERVICES, 7285 W. Eagle Court, Winton, CA, 95388, US

(73) Assignee: LINKAGE TECHNOLOGY GROUP CO., LTD., Nanjing (CN)

(21) Appl. No.: 12/644,965

(22) Filed: Dec. 22, 2009

(30) Foreign Application Priority Data
Jan. 9, 2009 (CN) 200910028106.1

(51) Int. Cl. G06F 17/30

(52) U.S. Cl. 707/747; 707/E17.002

(57) ABSTRACT

For the massive data of physical memory on the computer system, data indexing can be created base on the two-dimensional hash indexing algorithm, using specific mapping relationship conversion between the index keyword and index sequence address under hash algorithm, which realize the fast addressing while introducing two-dimensional hash list to solve the ‘confliction’ problem of mapping relations in hash queue, which caused by the same keyword index or hash algorithm.

### CROSS REFERENCE TO RELATED PATENT APPLICATION

This application claims the priority of the Chinese patent application No. 200910028106.1 filed on Sep. 1, 2009, which application is incorporated herein by reference.

### FIELD OF THE INVENTION

The invention represents a method used in the telecommunication operation support system, especially the rapid mass data manipulation.

### BACKGROUND OF THE INVENTION

Along with the rapid development of the telecom industry and business users, how to deal with millions of phone call data quickly has become difficult and top-priority for the telecom operators. Application of the current system needs to enquire, update and delete huge amounts of data frequently existing in physical memory of computer systems. Obviously, the data index key algorithm will greatly affect the efficiency of the computer running speed.

The existing one-way hash function refers to the value of fixed-length output algorithm based on the input information (any byte string, such as text strings, Word documents, JPG files, etc.), the output value, is also known as “hashed value” or “message abstract”, and its length depends on the algorithm used, usually between 128˜256. One-way hash function aims at creating the short message abstract to validate integrity of the messages. In TPC/IP communication protocol, testing and CRC (Cyclic Redundancy Check) are often used to verify the integrity of the news.

### SUMMARY OF THE INVENTION

The purpose of the invention is to announce the quick mass data manipulation method based on two-dimension hash, used for telecom operation system, which requires massive database, quick response, stable and self-maintained. This invention is designed to resolve the following issues:

Highly efficient data searching when the managed data can be well-proportioned distributed based on keywords searching result, it can even addressing directly and returns with a keywords related records list. No need to recreate the index if data records update, also can be expanded dynamically. With data index structure of this invention, efficiency of data searching for millions of data records can be raised to microsecond level. It greatly satisfies the technological request from the telecom operation system.

Technical proposal of this invention: The quick mass data manipulation method is based on two-dimension hash. First, it uses hash algorithms to set the data records into specific sequence and form a specific mapping relations between indexed keywords and indexed address sequence, here one-dimension hash structure is set up to store the data; when the mapping relations between indexed keywords and index sequence address cannot addressing for data records, a two-dimension hash link sheet would be constructed based on the same index keywords or not, and link it with the hash in the first layer of each node of the queue as an node expansion of two-dimension hash queue to distinguish the index field values.

When the data operation according to the keywords index is needed, according to the same hashing algorithm, reversing mapping from the one-dimension, to obtain corresponding address of the keyword index data record and rapidly addressing; if two-dimension hash link sheet is found under one-dimension hash node queue, then look up the data record address based on the keywords value through the two-dimension hash link sheet.

Create Index Interface:

In order to realize the conversion of specific mapping between the index keywords and the index sequence, subscript value of hash queue needs to be calculated according to the keywords; If the one-to-one corresponding relationship cannot be matched between the index key words of each data record and the subscript value based on the hashing algorithm, a 2-dimension hash link table would be extended to link to the hash in the first layer of each node queue to distinguish the index field values, make sure the conflicts would disappear. According to the mapping relationship above, quick data sets index structure is available.

Query Interface:

When operating the data set by using the index key words, firstly the data set index access which has already been created needs to be found, using the same hash algorithm to calculate the subscript value and reverse mapping from the 1 dimension hash queue to acquire the corresponding data record address with the index keywords and rapidly addressing; if two-dimension hash table is found under the one-dimension hash node queue, then search the data records address from two-dimension hash table according to the enquired keywords value; Finally, return the result.

This invention is mainly divided into two parts: hash algorithm and two-dimension hash algorithm.

Hash Algorithm
Calculate hash queue subscript value based on keyword indexing, to achieve specific mapping relationship conversion between the index keyword and index sequence address

Two-Dimensional Hash Algorithm
Since it cannot be guaranteed to be one-one correspondence between the index key words of each data record and the subscript value based on the hashing algorithm, it is probably that input different factors but obtain the same hash queue subscript value also called same index field value after the calculation using hash algorithm. Or it is probably non-single, thus “conflict” will exist. So a two-dimension hash link table is designed, which is under the 1^{st} layer of one-dimension hash node queue to distinguish the differences of index field value and expand horizontally or vertically, which makes the conflicts disappear, i.e. the calculation of double index hash line tables.

The effective practice of this invention: the invention has been successfully applied in memory data management products, and also has become the main technical proposals of critical business data management in the core telecom operators in China deployed in the background of business processing system in expense accounts which has contributed to a 50%˜80% improvement in business treatment.

### BRIEF DESCRIPTION OF THE DRAWINGS

FIG. 1 is a logic structure of two-dimension hash index.

### DETAIL DESCRIPTION OF THE INVENTION

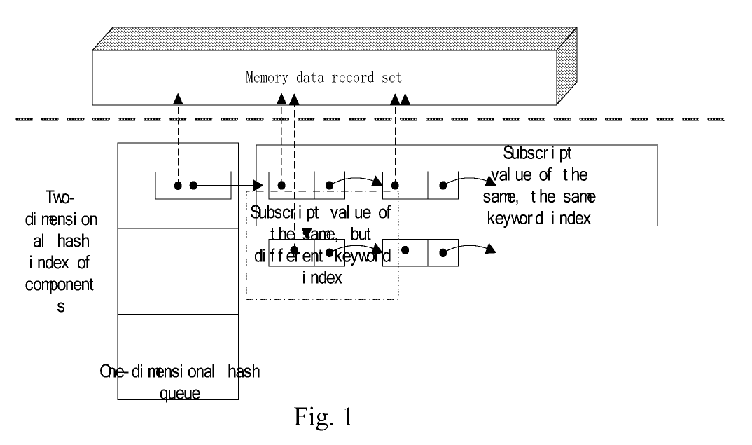

Currently, the invention is embedded in the memory data management of the index management module and also be an independent package to adapt to other modules as a third-party plug-in adapter. Standard software module. Here is one module applied inside of the index management, which is shown in FIG. 1.

Create Index Interface
Under the usage of the invented technology, subscript value of hash queue can be calculated according to the keywords ,which realizes the conversion of specific mapping between the index keywords and the index sequence, when the one-to-one corresponding relationship cannot be matched between the index key words of each data record and the subscript value based on the hashing algorithm, 2-dimension hash link table would be extended to link to the hash in the first layer of each node queue to distinguish the index field values to make sure conflicts would disappear. With maintenance of the above mapping relationship systematically, a quick index structure is available.

Query Interface
When operating the data set by using the index key words, firstly the data set index access that has already been created needs to be found, using the same hash algorithm to calculate the subscript value and reverse mapping from the 1 dimension hash queue to acquire the corresponding data record address with the index keywords and rapidly addressing; if two-dimension hash table is found under the one-dimension hash node queue, then search the data records address from two-dimension hash table according to the enquired keywords value. Finally, return the result.

What is claimed is:

1. A quick mass data manipulation method based on two-dimension hash comprising:
first, use hash algorithms to set the data records into specific sequence and form a specific mapping relations between indexed keywords and indexed address sequence, here one-dimension hash structure is set up to store the data; when the mapping relations between indexed keywords and index sequence address cannot addressing for data records, a two-dimension hash link sheet would be constructed based on the same index keywords or not, and link it to the hash in the first layer of each node of the queue as an node expansion of two-dimension hash queue to distinguish the index field values;
operate the data set by using the index key words, according to the same hash algorithm, reversing mapping from the 1 dimension hash queue to obtain the corresponding data record address with the index keywords and then rapidly addressing; if two-dimension hash table is found under the one-dimension hash node queue, then look up the data records address vertically base on keywords value through the two-dimension hash link sheet;
create index interface: In order to realize the conversion of specific mapping between the index keywords and the index sequence, subscript value of hash queue needs to be calculated according to the keywords; if the one-to-one corresponding relationship cannot be matched between the index key words of each data record and the subscript value based on the hashing algorithm, a 2-dimension hash link table would be extended to link to the hash in the first layer of each node queue to distinguish the index field values, make sure the conflicts would disappear. According to the mapping relationship above, quick data sets index structure is available;
query Interface: When operating the data set by using the index key words, firstly the data set index access which has already been created needs to be found, using the same hash algorithm to calculate the subscript value and reverse mapping from the 1 dimension hash queue to acquire the corresponding data record address with the index keywords and rapidly addressing; if two-dimension hash table is found under the one-dimension hash node queue, then search the data records address from two-dimension hash table according to the enquired keywords value; Finally, return the result;
Operational approach for quick mass data manipulation method based on two-dimension hash: firstly, using hash algorithms to set the data record into set specific sequence and form a specific mapping relations between index keywords and index-specific sequence of address sequence, here one-dimensional hash queue structure is set up to store the data; when the mapping relations between indexed keywords and index sequence address cannot addressing for data records, a two-dimension hash link sheet would be constructed based on the same index keywords or not, and link it to the hash in the first layer of each node of the queue as an node expansion of two-dimension hash queue; when necessary in accordance with the keyword index to operate on the data sets through the same hashing algorithm, reversing mapping from the 1 dimension hash queue to obtain the corresponding data record address with the index keywords and then rapidly addressing; if two-dimension hash table is found under the one-dimension hash node queue, then look up the data records address vertically base on keywords value through the two-dimension hash link sheet.
